(19) United States
(12) Patent Application Publication
(10) Pub. No.: US 2013/0207907 A1
(43) Pub. Date: Aug. 15, 2013

(54) TOUCH DEVICE AND TOUCH SENSING METHOD THEREOF

(71) Applicants: Shin-Hen Chao, Taoyuan County (TW); Chia-Hua Chang, Changhua County (TW); Shin-Yuan Peng, Taoyuan County (TW); Bo-Wei Lan, Taipei City (TW)

(72) Inventors: Shin-Hen Chao, Taoyuan County (TW); Chia-Hua Chang, Changhua County (TW); Shin-Yuan Peng, Taoyuan County (TW); Bo-Wei Lan, Taipei City (TW)

(73) Assignee: CHUNGHWA PICTURE TUBES, LTD., Taoyuan (TW)

(21) Appl. No.: 13/452,943

(22) Filed: Apr. 23, 2012

(30) Foreign Application Priority Data
Feb. 13, 2012 (TW) 101104565

(51) Int. Cl. G06F 3/041

(52) U.S. Cl. 345/173; 178/18.03

(57) ABSTRACT

A touch device and a touch sensing method thereof are provided. With driving lines and corresponding sensing lines are arranged alternately, the distance between the sensing lines is increased, so as to avoid touch quality being affected by the mutual interference caused by the sensing lines.

### CROSS-REFERENCE TO RELATED APPLICATION

This application claims the priority benefit of Taiwan application serial no. 101104565, filed on Feb. 13, 2012. The entirety of the above-mentioned patent application is hereby incorporated by reference herein and made a part of this specification.

### TECHNICAL FIELD

The invention relates to a touch device and touch sensing method thereof, more particularly to a touch sensing device in which mutual interferences between adjacent electrode traces is lowered and a sensing method thereof.

### BACKGROUND

As the demands on multi-touch technology increases, the projected capacitive touch technology becomes a mainstream in the touch panel technology. Since a human body is an excellent conductor, the capacitance generated by the combination of electrostatic charges of a transparent electrode (indium tin oxide, ITO) of a projected capacitive touch panel and the human body increases as the human body approaches the projected capacitive touch panel. The position of a touched point is thereby identified by detecting the changes in the electrostatic capacity of sensing lines on the projected capacitive touch panel.

In a traditional projected capacitive touch panel, the coordinate matrix is constructed by a plurality x-axis line transparent electrodes and a plurality of y-axis line transparent electrodes that are interlaced and perpendicular to each other, wherein when the y-axis lines are driven, the changes in the capacity of the x-axis lines are detected to determine the position of the touched point. According to the structure of the traditional projected capacitive touch panel, the adjacent electrodes are of the same type electrodes; hence, coupling interferences may occur between the adjacent electrodes, leading to erroneous determination of the position of the touched point.

### SUMMARY

An exemplary embodiment of the disclosure provides a touch device and a touch sensing method thereof, in which mutual interference between adjacent electrode traces is reduced to enhance the touch quality.

An exemplary embodiment of the disclosure provides a touch device that includes a touch panel, a driving unit, a sensing unit, a processing unit. The touch panel includes a plurality of first driving lines, a plurality of second driving lines, a plurality of first sensing lines, a plurality of second sensing lines. The first sensing lines and the first driving lines are alternately arranged and extending along a first direction, and the second sensing lines and the second driving lines are alternately arranged and extending along a second direction. The driving unit is coupled to the plurality of first driving lines and the plurality of second driving lines. The plurality of first driving lines and the plurality of second driving lines are sequentially driven. The sensing unit is coupled to the plurality of first sensing lines and the plurality of second sensing lines, and senses the voltage change of at least one of the two first sensing lines adjacent to a driven first driving line, and the voltage change of the at least one of the two second sensing lines adjacent to a driven second driving lines. The processing unit is coupled to the sensing unit and determines the touch position on the touch panel according to the sensing results of the sensing unit.

According to an exemplary embodiment of the disclosure, the touch panel includes adjacent first side and second side, and the driving unit is disposed at the first side and the second side and the sensing unit is disposed at the first side and the second side.

According to an exemplary embodiment of the disclosure, the touch panel includes a first side, a second side and a third side, wherein the second side and the third side are opposite to each other, and the first side is adjacent respectively to the second side and the third side, and the driving unit is disposed at the first side and the second side, and the sensing unit is disposed at the first side and the third side.

According to an exemplary embodiment of the disclosure, the touch panel includes a second side and the third side configured opposite to each other, and first side and the fourth side configured opposite to each other, wherein the driving unit is configured at the first side and the second side, and the sensing unit is configured at the third side and the fourth side, wherein the first side, the second side, the third side and the fourth side respectively include adjacent sensing lines and driving lines that are alternately arranged.

An exemplary embodiment of the disclosure provides a touch sensing method of a touch device that includes a plurality of first driving lines, a plurality of second driving lines, a plurality of first sensing lines, and a plurality of second sensing lines, wherein the plurality of first driving lines and the plurality of first sensing line are alternately arranged and extending along a first direction, and the plurality of second driving lines and the plurality of second sensing lines are alternately arranged and extending along a second direction. The touch sensing method includes sequentially driving the plurality of first driving lines and concurrently sensing a voltage change of at least one of two of the plurality of first sensing lines adjacent to a driven first driving line of the plurality of first driving lines; sequentially driving the plurality of second driving lines and concurrently sensing a voltage change of at least one of two of the plurality of second sensing lines adjacent to a driven second driving line of the plurality of second driving lines; and determining a touch position on the touch panel according a sensing result of the sensing unit.

According to an exemplary embodiment of the disclosure, the first direction is perpendicular to the second direction.

According to an exemplary embodiment of the disclosure, the distance between adjacent sensing lines is extended through the alternate arrangement of the driving lines and the sensing lines. Hence, the mutual interference between the adjacent sensing lines is reduced to improve the touch quality of a touch device.

The invention and certain merits provided by the invention can be better understood by way of the following exemplary embodiments and the accompanying drawings, which are not to be construed as limiting the scope of the invention.

### BRIEF DESCRIPTION OF THE DRAWINGS

FIG. 1 is a schematic diagram of a touch device according to an exemplary embodiment of the disclosure.

FIG. 2 illustrates the touch sensing situation of the touch device of the first exemplary embodiment of the disclosure.

FIG. 3 illustrates the voltage changes of the driving lines and the sensing lines of the exemplary embodiment in FIG. 2.

FIG. 4 is a schematic diagram illustrating a touch device according to an exemplary embodiment of the disclosure.

FIG. 5 is a schematic diagram illustrating a touch device according to an exemplary embodiment of the disclosure.

FIG. 6 is a flow chart of steps of an exemplary touch sensing method of the touch device of an exemplary embodiment of the disclosure.

### DETAILED DESCRIPTION OF DISCLOSED EMBODIMENTS

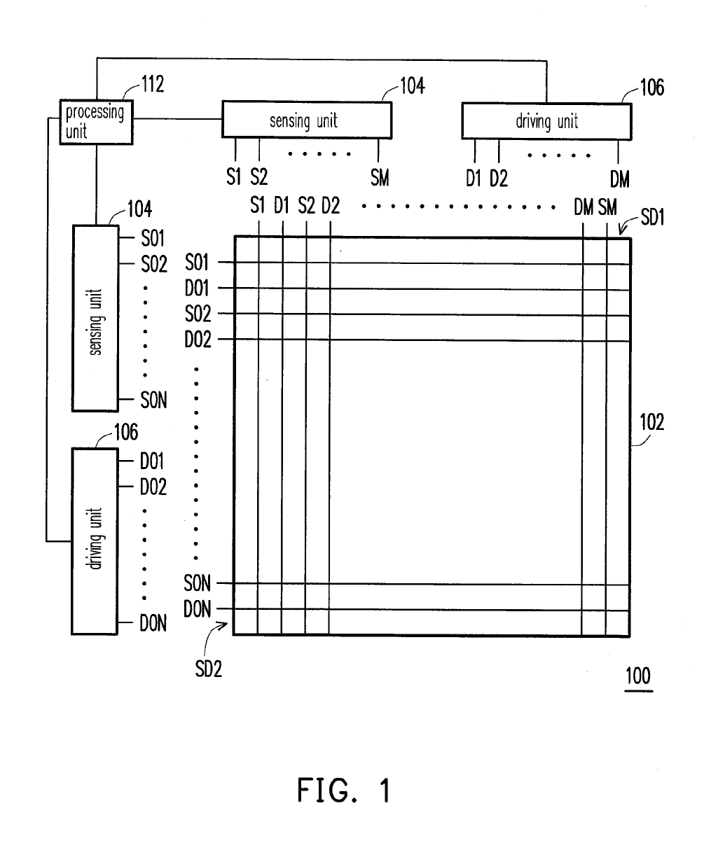

FIG. 1 is a schematic diagram of a touch device according to an exemplary embodiment of the disclosure. Referring to FIG. 1, a touch device 100 includes a touch panel 102, a touch sensing unit 104, a driving unit 106 and a processing unit 112. The touch panel 102 includes a plurality of first driving lines D1 to DM, a plurality of second driving lines D01 to D0N, a plurality of first touch sensing lines S1 to SM and a plurality of second touch sensing lines S01 to S0N, wherein M and N are positive integers. The plurality of first driving lines D1 to DM and the plurality of first touch sensing lines S1 to SM are alternately arranged along a first direction and the plurality of the second sensing lines S01 to S0N and the plurality of second driving lines D01 to DON are alternately arranged along a second direction. In this exemplary embodiment, the first direction is perpendicular to the second direction.

Additionally, the driving unit 106 is coupled to the first driving lines D1 to DM and the second driving lines D01 to D0N, while the touch sensing unit 104 is coupled to the first sensing lines S1 to SM and the second sensing lines S01 to S0N. The driving unit 106 is disposed at a first side SD1 and a second side SD2 of the touch panel 102. The touch sensing unit 104 is also configured at the first side SD1 and the second side SD2 of the touch panel 102, wherein the first side SD1 is adjacent to the second side SD2. In other exemplary embodiments, the driving unit 104 and the sensing unit 106 are integrated on a chip. Moreover, the processing unit 112 is coupled to the sensing unit 104.

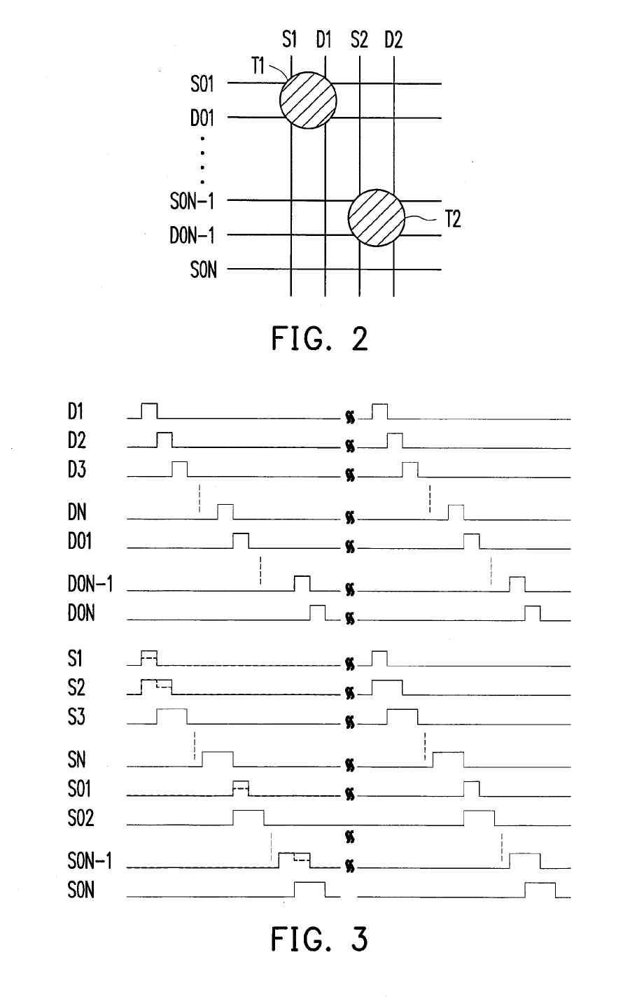

As shown in FIG. 1, the driving unit 106 may sequentially drive the first driving lines D1 to DM. While the driving unit 106 is driving the first driving lines D1 to DM, concurrently, the touch sensing unit 104 senses the voltage change of two corresponding first sensing lines that are adjacent to the driven first driving lines D1 to DM. For example, FIG. 2 illustrates the touch sensing situation of the touch device of the first exemplary embodiment of the disclosure, and FIG. 3 illustrates the voltage changes of on the driving lines and the sensing lines of the exemplary embodiment in FIG. 2. Referring concurrently to FIGS. 2 and 3, when the first driving line D1 is driven, the touch sensing unit 104 senses the voltage changes of the first sensing lines S1 and S2. When the first driving line D2 is driven, the touch sensing unit 104 senses the voltage changes of the first sensing lines S2 and S3. Correspondingly, the first driving lines D2 to DM are driven in a similar manner. As shown in FIG. 3, the position of the touched point T1 causes a voltage change on the first sensing line. Alternatively speaking, the voltage level of the first sensing line S1 is lower than that before the first sensing line S1 was being touched.

Similarly, after the first driving lines D1 to DM are driven, the driving unit 106 starts to drive the second driving lines D01 to D0N sequentially. When the driving unit 106 is driving the second driving lines D01 to D0N, the sensing unit 104 senses the voltage changes of tow second sensing lines adjacent to the driven second driving lines. For example, when the second driving line D0N-1 is driven, the sensing unit 104 senses the voltage changes of the second sensing line S0N-1 and S0N, and when the second driving line D01 is driven, the sensing unit 104 senses the voltage changes of the second sensing lines S2 and S3. Correspondingly, the second driving lines D01 to D0N are driven in a similar manner. For example, as shown in FIG. 3, when the second driving line D0N-1 is driven, the sensing unit 104 senses the voltage changes of the second sensing lines S0N-1 to S0N, wherein the touch point T2 creates the voltage changes on the second sensing line S0N-1. In other words, the voltage level of the second sensing line S0N-1 is lower than the voltage level prior to being touched.

Moreover, the processing unit 112 determines the position of the touched point of the touch panel 102 based on the sensing results of the touch sensing unit 104. Since the distance between the adjacent sense lines are extended by the alternate arrangement of the driving lines and the sensing lines, the interference between the adjacent sensing lines is also greatly reduced. The touch quality of the touch device 100 is improved accordingly. In other exemplary embodiments, if the driving lines and the sensing lines are alternately arranged, the original number of the sensing lines is reduced. Accordingly, the resistance of the electrode is lower, while the sensing ability and the transmission speed of the touch device are enhanced. Moreover, the report rate also increases. If the original number of the sensing lines remains unchanged, which means the number of the electrode traces becomes double, the touch sensing resolution is increased. Moreover, since each touch point on the touch panel 102 will be subjected to a first direction scan sensing and a second direction scan sensing, the coordinate of the touch point is accurately attained based on the confirmation of the two scan sensings and the problem of ghost point can be obviated.

It is worthy to note that, in other exemplary embodiments, when the driving unit 106 drives the first driving lines D1 to DM, the touch sensing unit 104 also senses the voltage change of one of the two sensing lines adjacent to the driven first driving lines. The details of the implementation of the exemplary device should be well known to a skilled artesian and will not be further reiterated herein.

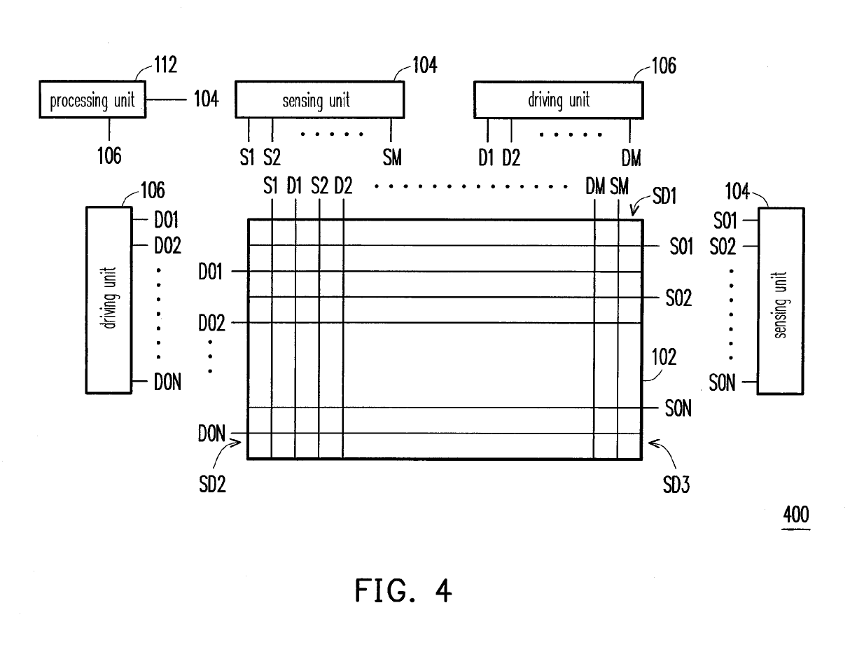

It is also worthy to note that although the disclosure herein refers to certain dispositions of the driving unit 106 and the sensing unit 104, it is to be understood that these embodiments are presented by way of example and not by way of limitation. In other exemplary embodiments, the driving unit 106 and the sensing unit 104 may be configured in different positions. For example, FIG. 4 is a schematic diagram illustrating a touch device according to another exemplary embodiment of the disclosure. Referring to FIG. 4, the difference between the touch device 400 in this exemplary embodiment and the touch device 100 in FIG. 1 lies in the sensing unit 104 being disposed at the first side SD1 and the third side SD3 of the touch panel 102, while the driving unit 106 is disposed at the first side SD1 and the second side SD2 of the touch panel 102.

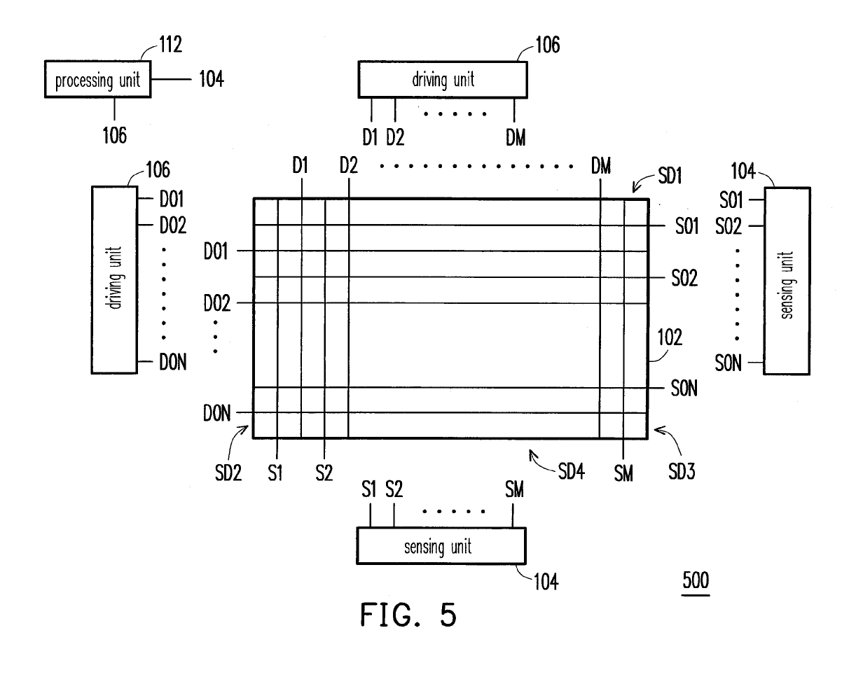

Another example is illustrated in FIG. 5. FIG. 5 is a schematic diagram of a touch device according to another exemplary embodiment of the disclosure. Referring to FIG. 5, the difference between the touch device 500 in this exemplary embodiment and the touch device 400 in FIG. 4 lies in the disposition of the sensing unit 104. In this exemplary embodiment, the sensing unit 104 is configured at the third side SD3 and the fourth side SD4 of the touch panel 102. As noted above, The only difference between the touch devices in FIG. 1, 4, 5 falls on the configuration of the drive unit 106 and the sensing unit 104. In essence, during a practical implementation, the disposition of the driving unit 106 and the sensing unit 104 determined by and correlated with the design of the input/output pins on the touch panel 102. The touch sensing method of the touch device of this exemplary embodiment is similar to the devices in other exemplary embodiments; hence, the details thereof are not further discussed herein.

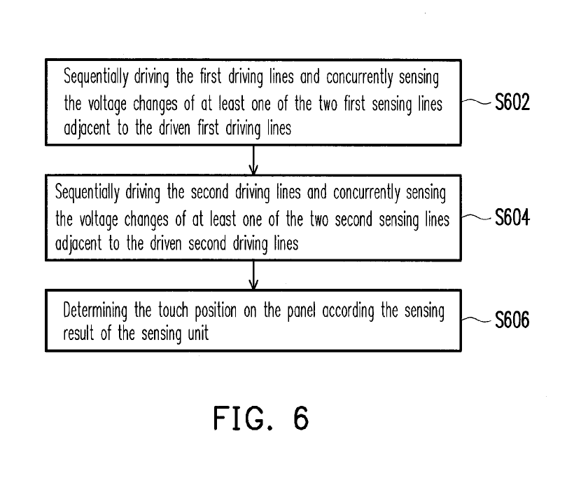

FIG. 6 is a flow chart of steps of exemplary touch sensing methods of the touch device of an exemplary embodiment of the disclosure. Referring to FIG. 6, the touch sensing methods of the above touch device may be summarized to include the following steps. The first driving lines are driven and the voltage change of the at least one of the two first sensing lines adjacent to the driven first driving lines is sensed concurrently (Step S602). Then, the second driving lines are driven and the voltage change of the at least one of the two sensing lines adjacent to the driven second driving lines is sensed concurrently (Step S604). Ultimately, according to the sensing results of the sensing unit, the touch position on the touch panel is determined (Step 606).

According to the exemplary embodiments of the disclosure, the distance between adjacent sensing lines is extended through the alternate arrangement of the driving lines and the sensing lines. Hence, the mutual interference between the adjacent sensing lines is reduced to improve the touch quality of a touch device and to avoid the appearance of ghost point. Moreover, in other exemplary embodiments, through the alternate arrangement of the driving lines and the sensing lines, the original number of the sensing lines is reduced by half to lower the resistance of the electrode trace and to increase the sensing capability of the touch device, the transmission speed and the report rate. If the number of the sensing lines remains unchanged, which implies the number of the electrode traces becomes double, the resolution of touch sensing is enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch device, comprising:
a touch panel, comprising:
a plurality of first driving lines;
a plurality of second driving lines;
a plurality of first sensing lines, the plurality of first driving lines and the plurality of first sensing line arranged alternately and extending along a first direction; and
a plurality of second sensing lines, the plurality of second driving lines and the plurality of second sensing line arranged alternately and extending along a second direction;
a driving unit, coupled to the plurality of first driving lines and the plurality of second driving lines, and sequentially driving the plurality of first driving lines and the plurality of second driving lines;
a sensing unit, coupled to the plurality of first sensing lines and the plurality of second sensing lines, and sensing a voltage change of at least one of two of the plurality of first sensing lines adjacent to a driven first driving line of the plurality of first driving lines and a voltage change of at least one of two of the plurality of second sensing lines adjacent to a driven second driving line of the plurality of second driving lines; and
a processing unit, coupled to the sensing unit and determining a touch position of the touch panel according a touch sensing result of the sensing unit.

2. The touch device of claim 1, wherein the touch panel comprises a first side and a second side adjacent to each other, and the driving unit is disposed at the first side and the second side and the sensing unit is disposed at the first side and the second side.

3. The touch device of claim 1, wherein the touch panel comprises a first side, a second side and a third side, wherein the second side and the third side are opposite to each other, and the second side and the third side are adjacent to the first side respectively, and the driving unit is disposed at the first side and the second side, and the sensing unit is disposed at the first side and the third side.

4. The touch device of claim 1, wherein the touch panel includes a second side and the third side configured opposite to each other, and a first side and a fourth side configured opposite to each other, wherein the driving unit is configured at the first side and the second side, and the sensing unit is configured at the third side and the fourth side.

5. The touch device of claim 1, wherein the first direction is perpendicular to the second direction.

6. A touch sensing method of a touch device, the touch device comprising a touch panel comprising a plurality of first driving lines, a plurality of second driving lines, a plurality of first sensing lines, and a plurality of second sensing lines, wherein the plurality of first driving lines and the plurality of first sensing line are alternately arranged and extending along a first direction, and the plurality of second driving lines and the plurality of second sensing line are alternately arranged and extending along a second direction, the touch sensing method of the touch device, comprising:
sequentially driving the plurality of first driving lines and concurrently sensing a voltage change of at least one of two of the plurality of first sensing lines adjacent to a driven first driving line of the plurality of first driving lines;
sequentially driving the plurality of second driving lines and concurrently sensing a voltage change of at least one of two of the plurality of second sensing lines adjacent to a driven second driving line of the plurality of second driving lines;
determining a touch position on the touch panel according a sensing result of the sensing unit.

7. The touch sensing method of claim 6, wherein the second direction is perpendicular to the first direction.
